(19) United States
(12) Patent Application Publication
(10) Pub. No.: US 2010/0094621 A1
(43) Pub. Date: Apr. 15, 2010

(54) System and Method for Assessing Script Running Time

(76) Inventors: Seth Kenvin, San Francisco, CA (US); Neal Clark, San Francisco, CA (US); Jeremy Gailor, San Francisco, CA (US); Michael Dungan, San Francisco, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/562,030

(22) Filed: Sep. 17, 2009

Related U.S. Application Data
(60) Provisional application No. 61/097,644, filed on Sep. 17, 2008.

(51) Int. Cl. G10L 11/06

(52) U.S. Cl. 704/215; 704/E11.007

(57) ABSTRACT

A method and system for assessing script running time are disclosed. According to one embodiment, a computer implemented method comprises receiving a first input from a client, wherein the first input comprises a script, the script comprising spoken audio and video elements. A second input is received from the client, wherein the second input comprises a value of words per minute. A third input is received from the client, wherein the third input comprises a non-verbal duration. A duration of the spoken audio of the script is calculated by multiplying the value of words per minute and the spoken content of the script. A duration of the script is calculated by summing the duration of the spoken audio and the non-verbal duration and the duration of the script is returned to the client.

The present application claims the benefit of and priority to U.S. Provisional Patent Application No. 61/097,641 entitled “A System and Method for Assessing Script Running Time” filed on Sep. 17, 2008, and is hereby, incorporated by reference.

### FIELD

The present system relates in general to computer applications and, more specifically, to a system and method for assessing script running time.

### BACKGROUND

Running times of completed video are a frequent bone of contention between participants in relevant creative projects. There are differing visions of total duration suitable for intentions in a big picture sense. Those who stress that a particular video project merits lengthy and elaborate treatment are likely to encounter other, qualified stakeholders in the same projects who contend that distillation of only most vital elements into a shorter play time featuring the most vital content has merit.

Differences on planned running times are also often encountered when more detailed scripting work is underway. Parties plead for inclusion of particular spoken dialog against objections from others involved in the same production.

Differences of opinion on durations for scripts are particularly common in the rising tide of corporate, institutional and other organizational video production. One reason is that in such project there is frequent distinction between some parties having subject matter expertise without video production expertise who typically advocate for more content, both from a big picture perspective and from that of suggesting particular details for script inclusion, and other parties more versed in video craft who stress the merit of shorter running times corresponding with more effective content.

Current practices often dictate that durations be agreed to in advance and efforts be made to script accordingly, or scripted towards some modest overage of footage in order to bring on some tightening, but not drastic, cutting of content while editing.

### SUMMARY

A method and system for assessing script running time are disclosed. According to one embodiment, a computer implemented method comprises receiving a first input from a client, wherein the first input comprises a script, the script comprising spoken audio and video elements. A second input is received from the client, wherein the second input comprises a value of words per minute. A third input is received from the client, wherein the third input comprises a non-verbal duration. A duration of the spoken audio of the script is calculated by multiplying the value of words per minute and the spoken content of the script. A duration of the script is calculated by summing the duration of the spoken audio and the non-verbal duration and the duration of the script is returned to the client.

### BRIEF DESCRIPTION

The accompanying drawings, which are included as part of the present specification, illustrate the presently preferred embodiment and together with the general description given above and the detailed description of the preferred embodiment given below serve to explain and teach the principles of the present invention.

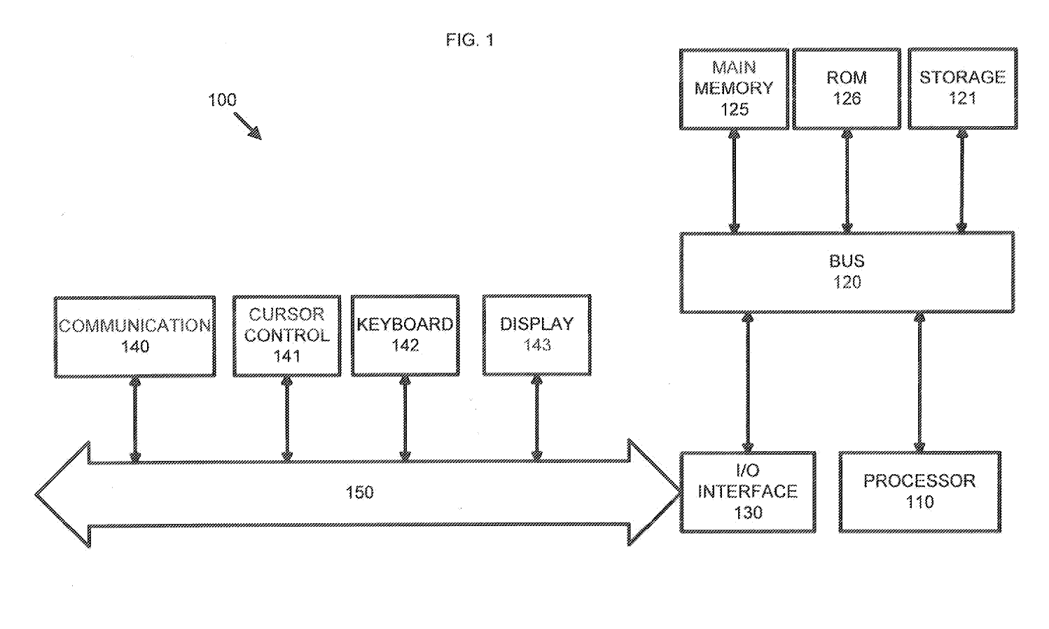

FIG. 1 illustrates an exemplary computer architecture for use with the present system, according to one embodiment.

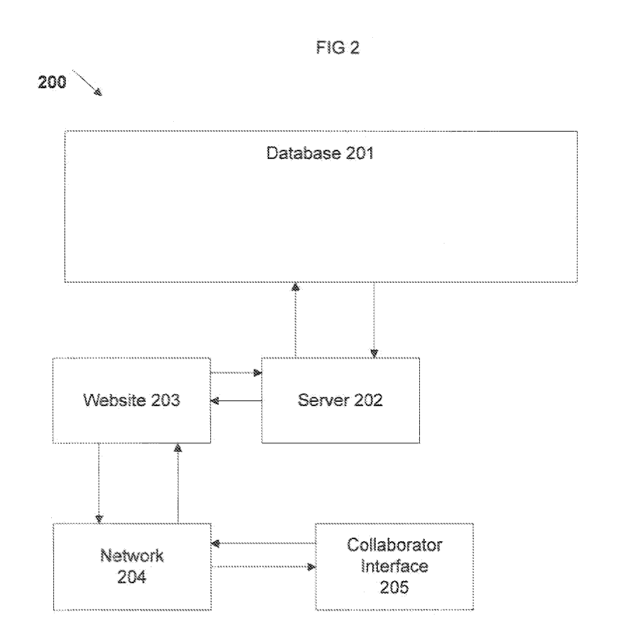

FIG. 2 is an exemplary system level diagram of a system for assessing script running time, according to one embodiment.

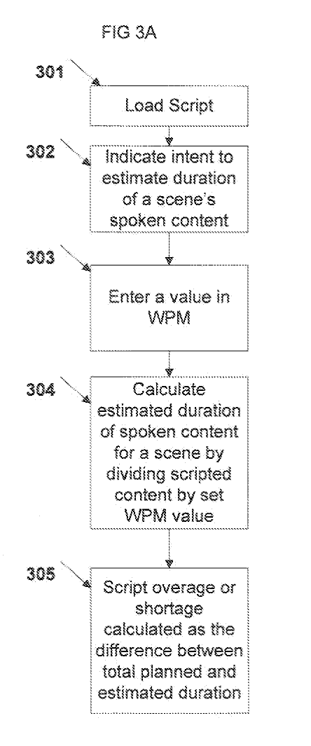

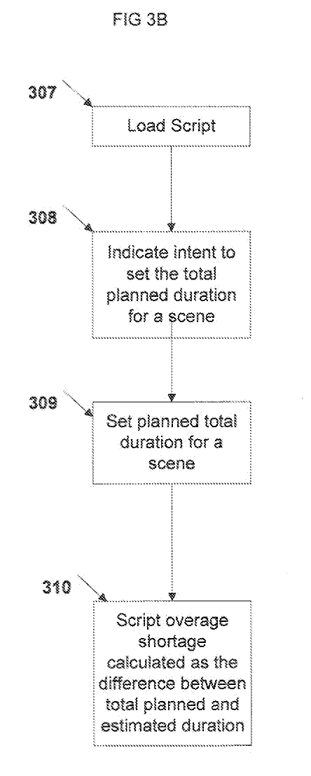

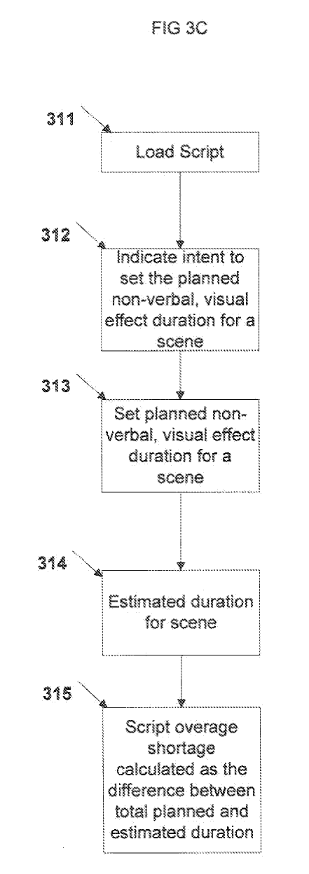

FIG. 3A is an exemplary interaction flow within a system for assessing script running time, according to one embodiment.

FIG. 3B is an exemplary interaction flow within a system for assessing script running time, according to one embodiment.

FIG. 3C is an exemplary interaction flow within a system for assessing script running time, according to one embodiment.

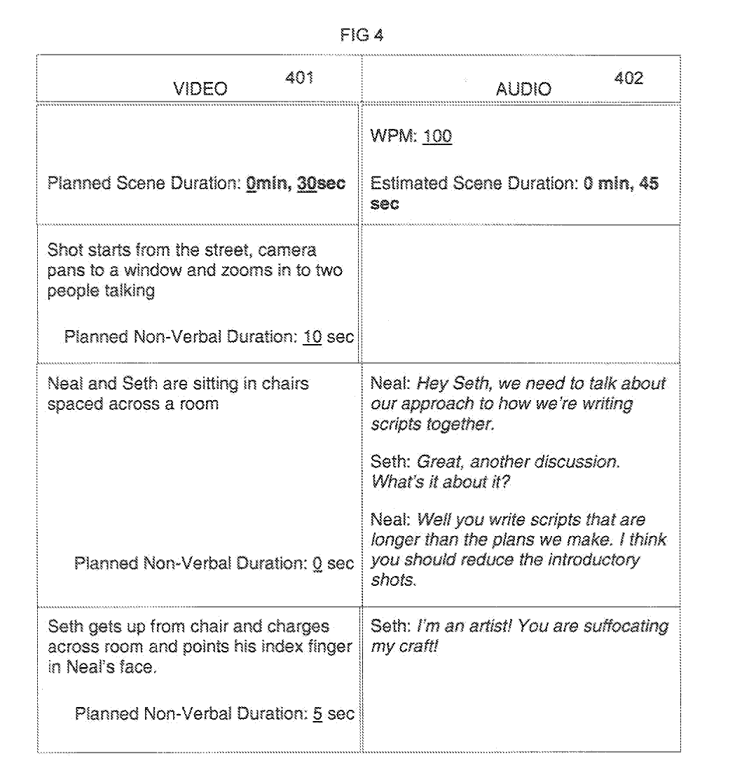

FIG. 4 illustrates an exemplary assessment of script running time.

### DETAILED DESCRIPTION

A method and system for assessing script running time are disclosed. According to one embodiment, a computer implemented method comprises receiving a first input from a client, wherein the first input comprises a script, the script comprising spoken audio and video elements. A second input is received from the client, wherein the second input comprises a value of words per minute. A third input is received from the client, wherein the third input comprises a non-verbal duration. A duration of the spoken audio of the script is calculated by multiplying the value of words per minute and the spoken content of the script. A duration of the script is calculated by summing the duration of the spoken audio and the non-verbal duration and the duration of the script is returned to the client.

The present system and method assesses script running time, based on written content and compares that to planned running times for particular scenes or entire scripts, so that appropriate consideration can be applied to how the duration of footage to be shot is likely to line up versus planned running time, and so that such information can factor into decisions made in advance of capturing footage or made during editing and post production.

Terms used throughout this description include the following.

Planned Duration Per Script: a single statistic in a time format (in minutes and seconds, as an example) for the entire script.

Planned Duration Per Scene: a time format statistic set for each scene; and planned duration for entire script equals the sum of all per-scene planned durations.

Words-Per-Minute Per Script: estimated audio duration of each scene is calculated by multiplying a single, script-wide WPM statistic by the number of words of scripted content to be spoken that's in the entire script.

Words-Per-Minute Per Scene: estimated audio duration of a scene calculated by multiplying a single WPM for the entire scene by the by the number of words of scripted content to be spoken in the given scene.

Words-Per-Minute Per Character: WPM statistics set for each individual character who has a speaking part and audio duration is estimated for each spoken passage by multiplying the corresponding speaker's WPM by the number of words in the passage. Duration for a scene is calculated by summing the estimated audio durations of each passage within. Duration for the entire script is calculated by summing all scenes within.

Words Per Minute Per Passage: Each spoken passage has its own WPM statistic. Audio duration for a scene is estimated by adding the multiplied products of the WPM statistic and the number of words contained for each passage within. Duration for the whole script is calculated by summing all scenes within.

Planned Non-Verbal Visual-Effect Duration Per Script: A single statistic in time format is provided for a script to correspond cumulatively to all portions within that script that require duration and that are not simultaneous with content to be spoken. This can be considered per-scene by allocating the per-script total equally across each scene or proportionally by amounts of content within given scenes.

Planned Non-Verbal Visual-Effect Duration Per Scene: A single statistic is set for each scene, for all portions within that scene that require duration and that are not simultaneous with content to be spoken. The total for an entire script can be determined by adding all of the per-scene values.

Planned Non-Verbal Visual-Effect Duration Per Visual Effect: Each visual effect that is scripted and not to be simultaneous with content to be spoken can receive its own planned duration value. Per-scene planned durations are calculated by summing all effects that have value within given scene. Per script durations are calculated by summing across all scenes accordingly

Total Estimated Duration: a duration calculated on a per-scene or per-script basis, regardless of granularity setting for variables, by adding respective Estimated Audio Duration and Planned Non-Verbal Visual-Effect Duration corresponding to scene or script under consideration.

According to one embodiment, a user gains access to a script editing software service by accessing a website hosted by the script editing software service. The user establishes an account with the script editing software service. The user account can be a free or paid subscription, each carrying varying levels of features. The user can generate and edit a script by utilizing the script editing software, and the running time of the script can be assessed using the present system and method.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present method and system also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the method and system as described herein.

FIG. 1 illustrates an exemplary computer architecture for use with the present system, according to one embodiment. One embodiment of architecture 100 comprises a system bus 120 for communicating information, and a processor 110 coupled to bus 120 for processing information. Architecture 100 further comprises a random access memory (RAM) or other dynamic storage device 125 (referred to herein as main memory), coupled to bus 120 for storing information and instructions to be executed by processor 110. Main memory 125 also may be used for storing temporary variables or other intermediate information during execution of instructions by processor 110. Architecture 100 also may include a read only memory (ROM) and/or other static storage device 126 coupled to bus 120 for storing static information and instructions used by processor 110.

A data storage device 127 such as a magnetic disk or optical disc and its corresponding drive may also be coupled to computer system 100 for storing information and instructions. Architecture 100 can also be coupled to a second I/O bus 150 via an I/O interface 130. A plurality of I/O devices may be coupled to I/O bus 150, including a display device 143, an input device (e.g., an alphanumeric input device 142 and/or a cursor control device 141).

The communication device 140 allows for access to other computers (servers or clients) via a network. The communication device 140 may comprise one or more modems, network interface cards, wireless network interfaces or other well known interface devices, such as those used for coupling to Ethernet, token ring, or other types of networks.

FIG. 2 is an exemplary system level diagram of a system for assessing script running time, according to one embodiment. A database 201 is in communication with a server 202. The server 202 hosts a website 203 and the website 203 is accessible over a network 204 (enterprise, or the internet, for example). A client transmits data to and receives data from the server 202 over the network 204 using a collaborator user interface 205. The server 202 and client systems have an architecture as described in FIG. 1, according to one embodiment.

FIG. 3A is an exemplary interaction flow within a system for assessing script running time, according to one embodiment. A script is loaded 301 containing a combination of spoken audio and descriptive video elements. The script is loaded using a collaborative user interface. Examples of descriptive video elements may include camera effects or on-stage directions like actor motion. Note that some of these elements may occur simultaneously with spoken parts, and others may not.

A user indicates, in the form of input to the user interface, an intent to estimate the duration of a scene's spoken content 302. The user enters a value in words-per-minute 303 for each particular scene, and the duration of the scene's spoken content is calculated using the scene's scripted content and the value in words-per-minute 304. The script overage or shortage is calculated as the difference between the planned duration (as defined by the user, according to one embodiment) and estimated duration 305.

FIG. 3B is an exemplary interaction flow within a system for assessing script running time, according to one embodiment. A script is loaded 307 containing a combination of spoken audio and descriptive video elements.

A user indicates an intent to set the planned duration of a scene 308. The user sets the planned duration of a scene 309. This may be a value in minutes and seconds, entered at the top of each scene's container. The script overage or shortage can be calculated as the difference between the planned and estimated durations of the scene 310.

FIG. 3C is an exemplary interaction flow within a system for assessing script running time, according to one embodiment. A script is loaded 311 containing a combination of spoken audio and descriptive video elements. A user indicates an intent to set the planned duration of non-verbal and visual effects of a scene 312. The user sets the planned duration of the non-verbal and visual effects of a scene 313. This may be a value in minutes and seconds, entered at the top of each scene's container. The estimated duration of the scene is calculated 314, and the script overage or shortage is calculated as the difference between the planned and estimated durations 315, using the planned non-verbal duration and a multiplied product of the scene's WPM variable times the number of scripted spoken words in the scene. The user can be advised about whether and to what degree the planned duration of the scene is higher than, equal to, or less than the estimated duration that is based on scripted elements.

An example according to the descriptions of FIGS. 3A, 3B, and 3C, follows. A user inputs 2 minutes as the planned duration of a scene. The user is prompted to enter a number of words-per-minute (WPM) to apply to the scene, and the user inputs 100 WPM. Given a scene with 150 words of spoken content, the estimated audio duration of 90 seconds is calculated (150 words/100 WPM×60 sec/min). The user is prompted for the duration of non-verbal visual-effects action planned for the scene, and the user inputs one minute. The system returns an indication that the planned scene duration is 2 minutes, whereas the estimated duration based on scripted elements is 2 and half minutes, that estimated duration being calculated as the sum of the 90 seconds estimated audio and 60 seconds planned non-verbal content. Thus, the estimated duration for the scripted content is 30 seconds longer than planned duration. The user can consider implementing changes to allow for a longer planned duration, reduce the scripted content, or decide to cut out 30 seconds of content in editing and post-production.

Variables can be considered differently than indicated by example heretofore, according to one embodiment. The planned duration can be set once for the entire script, instead of once per scene. The total planned non-verbal, visual-effect content can also be set with a single per-script figure, and a single WPM statistic could be applied across all scenes within a script. Alternatively, multiple non-verbal visual-effect passages within each scene may be distinguished, or WPM values may be set uniquely for each spoken passage. Yet another technique is to set a WPM value per speaker. If multiple speakers appear in the same, scene, then multiple WPM values are used within that scene. If a particular speaker appears in multiple scenes, that speaker's WPM value applies across all of their scenes. The present system allows any combination of these methods for setting planned duration, estimated audio duration (calculated as words of scripted content divided by WPM), and planned non-verbal visual-effect duration.

FIG. 4 illustrates an exemplary assessment of script running time. The flow is made up of video 401 and audio 402 elements, the combination of them making up scene duration. Video 401 elements include planned durations. The planned durations are manually input by a user and include a planned scene duration and planned non-verbal durations. Audio 402 elements include a manually input words-per-minute (WPM) value, and the system returns an estimated scene duration based on the defined WPM, the number of words included in the displayed dialogue, and the manually entered planned non-verbal durations.

A method and system for assessing script running time are disclosed. It is understood that the embodiments described herein are for the purpose of elucidation and should not be considered limiting the subject matter of the present embodiments. Various modifications, uses, substitutions, recombinations, improvements, methods of productions without departing from the scope or spirit of the present invention would be evident to a person skilled in the art.

We claim:

1. A computer implemented method, comprising:
receiving a first input from a client, wherein the first input comprises a script, the script comprising spoken audio and video elements;
receiving a second input from the client, wherein the second input comprises a value of words per minute;
receiving a third input from the client, wherein the third input comprises a non-verbal duration;
calculating a duration of the spoken audio of the script by multiplying the value of words per minute and the spoken content of the script;
calculating a duration of the script by summing the duration of the spoken audio and the non-verbal duration; and
returning the duration of the script to the client.

2. The computer implemented method of claim 1, further comprising:
receiving a fourth input from the client, wherein the fourth input comprises a planned script duration;
calculating the difference between the planned script duration and the duration of the script; and
returning the difference to the client.

3. The computer implemented method of claim 1, wherein the video elements comprise camera effects and actor motion.

4. The computer implemented method of claim 1, wherein the spoken audio and video elements occur simultaneously.

5. A computer implemented method, comprising:
receiving a first input from a client, wherein the first input comprises a script, the script comprising scenes, spoken audio and video elements;
receiving a second input from the client, wherein the second input comprises a value of words per minute;
receiving a third input from the client, wherein the third input comprises a scene of the script;
receiving a fourth input from the client, wherein the fourth input comprises a non-verbal duration of the scene;
calculating a duration of the spoken audio of the scene by multiplying the value of words per minute and the spoken content of the scene;
calculating a duration of the script by summing the duration of the spoken audio and the non-verbal duration of the scene; and
returning the duration of the scene to the client.

6. The computer implemented method of claim 5, further comprising:
receiving a fifth input from the client, wherein the fifth input comprises a planned scene duration;
calculating the difference between the planned scene duration and the duration of the scene; and
returning the difference to the client.

7. The computer implemented method of claim 5, wherein the video elements comprise camera effects and actor motion.

8. The computer implemented method of claim 5, wherein the spoken audio and video elements occur simultaneously.

9. A system, comprising:
a server hosting a website, the server in communication with a database, wherein the database stores script elements; and
a collaborator interface residing on the website, wherein the server
receives a first input from a client, wherein the first input comprises a script, the script comprising spoken audio and video elements;
receives a second input from the client, wherein the second input comprises a value of words per minute;
receives a third input from the client, wherein the third input comprises a non-verbal duration;
calculates a duration of the spoken audio of the script by multiplying the value of words per minute and the spoken content of the script;
calculates a duration of the script by summing the duration of the spoken audio and the non-verbal duration; and
returns the duration of the script to the client.

10. The system of claim 9, wherein the server further
receives a fourth input from the client, wherein the fourth input comprises a planned script duration;
calculates the difference between the planned script duration and the duration of the script; and
returns the difference to the client.

11. The system of claim 9, wherein the video elements comprise camera effects and actor motion.

12. The system of claim 9, wherein the spoken audio and video elements occur simultaneously.

13. A system, comprising:
a server hosting a website, the server in communication with a database, wherein the database stores script elements; and
a collaborator interface residing on the website, wherein the server
receives a first input from a client, wherein the first input comprises a script, the script comprising scenes, spoken audio and video elements;
receives a second input from the client, wherein the second input comprises a value of words per minute;
receives a third input from the client, wherein the third input comprises a scene of the script;
receives a fourth input from the client, wherein the fourth input comprises a non-verbal duration of the scene;
calculates a duration of the spoken audio of the scene by multiplying the value of words per minute and the spoken content of the scene;
calculates a duration of the script by summing the duration of the spoken audio and the non-verbal duration of the scene; and
returns the duration of the scene to the client.

14. The system of claim 13, wherein the server further
receives a fifth input from the client, wherein the fifth input comprises a planned scene duration;
calculates the difference between the planned scene duration and the duration of the scene; and
returns the difference to the client.

15. The system of claim 13, wherein the video elements comprise camera effects and actor motion.

16. The system of claim 13, wherein the spoken audio and video elements occur simultaneously.
